(19) United States
(12) Patent Application Publication
(10) Pub. No.: US 2013/0272687 A1
(43) Pub. Date: Oct. 17, 2013

(54) FRAME FOR MOUNTING REFLECTING PLATE AND BACKGROUND SHEET FOR PICTURE AND VIDEO SHOOTING THEREON

(71) Applicant: Jae Kyun YOO, Seoul (KR)

(72) Inventor: Jae Kyun YOO, Seoul (KR)

(21) Appl. No.: 13/863,884

(22) Filed: Apr. 16, 2013

(30) Foreign Application Priority Data
Apr. 16, 2012 (KR) 10-2012-0038962

(51) Int. Cl. G03B 15/00

(52) U.S. Cl. CPC G03B 15/00
USPC 396/5

(57) ABSTRACT

A frame for mounting a reflecting plate and a background sheet for picture and video shooting thereon includes: a body having a plurality of edge pipes coupled to each other to form a structure of a plane figure, each edge pipe being coupled at the end portions thereof to the edge pipe adjacent thereto; and a coupling string disposed inside the edge pipes in such a manner as to be connected at both ends thereof to maintain an integral structure even in a state where the edge pipes are separated from each other, the coupling string having given expandability.

### CROSS REFERENCES

This application claims the benefit of Korean Patent Application No. 10-2012-0038962, filed Apr. 16, 2012, which is hereby incorporated by reference in its entirety into this application.

### BACKGROUND OF THE INVENTION

1. Field of the Invention

The present invention relates to a frame for mounting a reflecting plate and a background sheet for picture and video shooting thereon, and more particularly, to a frame for mounting a reflecting plate and a background sheet for picture and video shooting thereon that is provided to mount the reflecting plate and the background sheet thereon, so that upon the picture and video shooting, light is reflected or transmitted and the background sheet mounted on the frame is used as background, thereby providing many conveniences in use.

2. Background of the Related Art

So as to ensure a given quantity of light in a place where a quantity of light is not sufficient, generally, a shutter speed of a camera is slow or an aperture is more open, thereby performing picture shooting. Alternatively, a degree of sensitivity (that is, an ISO (International Standards Organization) value) is increased, thereby performing picture shooting.

In case where the shutter speed of the camera is slow, however, the exposure time is extended to make the picture not vivid. On the other hand, in case where the aperture is more open, the quantity of light is ensured, but it is hard to obtain the picture having desired effects. If the ISO value is raised, further, noise generally occurs on the picture. Accordingly, the above-mentioned methods have the respective limitations in ensuring the given quantity of light.

The quantity of light is still insufficient through the above-mentioned methods, and if the above-mentioned methods are not adequate in providing the quantity of light due to their adverse effects, a camera flash provides a sufficient quantity of light required for picture shooting and is useful in ensuring the shutter speed in a dark place.

The camera flash used for picture shooting is a device for generating light at the moment of the picture shooting to allow the shooting to be conducted even in dark environments. There are many kinds of camera flashes. That is, in case of some kinds of camera flashes, they are carried into a user's bag or the like in a state of being separated from the cameras, and whenever needed, they are mounted on the cameras. In case of other kinds of camera flashes, they are embedded into the cameras.

In case where the camera flash is mounted on the camera if needed, the angle of light irradiation is adjustable to a desired direction, which allows shooting to be conducted with a variety of techniques, but in case where the camera flash is embedded in the camera, light is illuminated only to the forward direction, not to a desired arbitrary direction, so that if a lens direction is different from an object direction, a sufficient quantity of light is not illuminated to the object, thereby making it hard to obtain a desired quality of picture.

As mentioned above, that is, there is a limit in the adjustment of the light irradiation direction in case of the embedded camera flash, and accordingly, a separate reflecting plate is provided to adjust the light irradiation angle to a desired direction.

The reflecting plate has a shape of a generally circular or rectangular plate and is typically formed of a metal plate.

However, the conventional reflecting plate is bulky in size, heavy in weight, very inconvenient in delivery and use, and occupies large space at the time of being kept.

So as to remove the above-mentioned problems, thus, a plurality of bars serving as a frame of the reflecting plate is fitted to each other to constitute a single frame structure, which makes it convenient to be moved and kept.

In case of the coupling of the plurality of bars, however, the coupled portions are not fixedly fitted to each other, thereby failing to stably fix the reflecting plate thereto. If the bars are lost, it is impossible to assemble the reflecting plate itself. Further, in case where a large-sized reflecting plate is used, fixing bars are fastened on the centers of the frame. So as to allow the fixing bars to be detachably mounted on the frame in stable and rapid manners and to rigidly fix the frame when coupled to the frame, in this case, there is a need for the development of a new frame.

### SUMMARY OF THE INVENTION

Accordingly, the present invention has been made in view of the above-mentioned problems occurring in the prior art, and it is an object of the present invention to provide a frame for mounting a reflecting plate and a background sheet for picture and video shooting thereon that is capable of coupling a plurality of edge pipes to each other when used and separating the edge pipes from each other when not used, thereby reducing the whole size, making it convenient to be moved, and minimizing the space needed for keeping.

To accomplish the above object, there is provided a frame for mounting a reflecting plate and a background sheet for picture and video shooting thereon, the frame including: a body having a plurality of edge pipes coupled to each other to form a structure of a plane figure, each edge pipe being coupled at the end portions thereof to the edge pipe adjacent thereto; and a coupling string disposed inside the edge pipes in such a manner as to be connected at both ends thereof to maintain an integral structure even in a state where the edge pipes are separated from each other, the coupling string having given expandability.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a frame for mounting a reflecting plate and a background sheet for picture and video shooting thereon according to the present invention;

FIG. 2 is a perspective view showing the separated structure of the frame according to the present invention;

FIG. 3 is a sectional view showing the coupled structure of the frame according to the present invention;

FIG. 4 is a perspective view showing an example of coupling means adopted in the present invention; and

FIG. 5 is a perspective view showing another example of coupling means adopted in the present invention.

### DETAILED DESCRIPTION OF THE PREFERRED EMBODIMENT

Hereinafter, an explanation on a frame for mounting a reflecting plate and a background sheet for picture and video shooting thereon (hereinafter, which is referred simply as ‘frame’) according to the present invention will be in detail given with reference to the attached drawing.

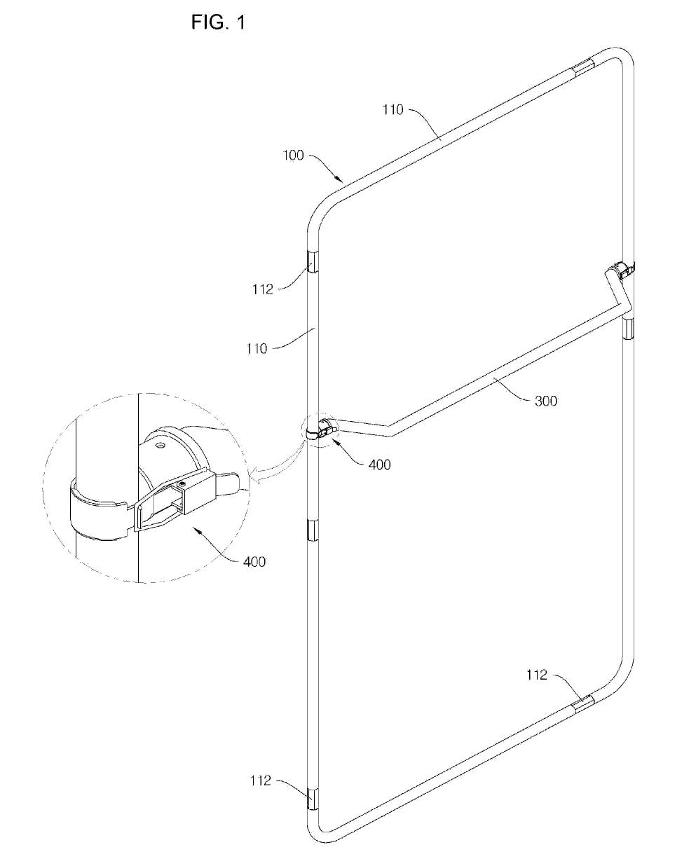

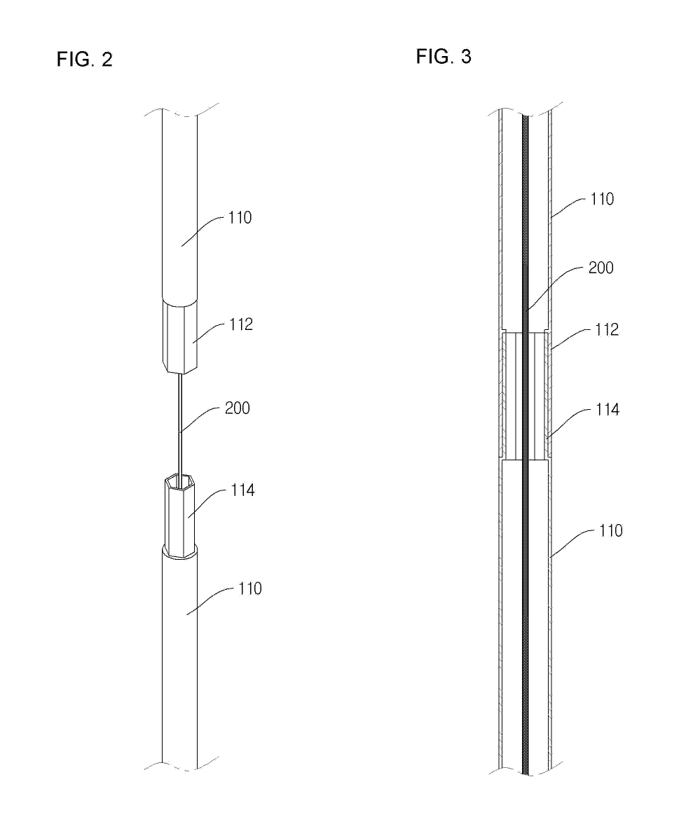

FIG. 1 is a perspective view showing the frame according to the present invention, and FIG. 2 is a perspective view showing the separated structure of the frame according to the present invention.

Referring to FIGS. 1 and 2, the frame according to the present invention includes: a body 100 formed by coupling a plurality of edge pipes 110 to each other; and a coupling string 200 disposed inside the plurality of edge pipes 110 in such a manner as to be connected at both ends thereof.

In more detail, each part of the frame according to the present invention will be explained with reference to the drawing.

Referring to FIG. 1, the frame according to the present invention includes the body 100.

The body 100 serves to provide an outer shape of a reflecting plate or a background sheet for picture or video shooting, that is, to support the edges of the reflecting plate or the background sheet in such a manner as to allow the reflecting plate or the background sheet to be kept stretched out.

Accordingly, the body 100 has the plurality of edge pipes 110 coupled to each other, and that is, the end portion of one edge pipe 110 is coupled to the end portion of the edge pipe 110 adjacent thereto, thereby forming a structure of a plane figure. In this case, the plane figure may include circle, rectangle, square, triangle, pentagon and the like, but desirably, it includes circle or rectangle. Further, the body 100 may have various sizes such as 1.1 m×2 m, 1.5 m×2 m, 2.4 m×2.4 m and the like in accordance with its purposes.

Only if the edge pipes 110 form the structure of the plane figure, they may have no limitation in their structure, but as shown in FIG. 1, they include linear pipes and “┐”-shaped bent pipes.

So as to allow the edge pipes 110 to be coupled easily to each other, further, each edge pipe 110 has a reduced pipe 114 disposed at one side thereof and an enlarged pipe 112 disposed at the other side corresponding to one side thereof. At this time, the enlarged pipe 112 has the inner peripheral surface having the same shape as the outer peripheral surface of the reduced pipe 114, so that the reduced pipe 114 is insertedly coupled to the enlarged pipe 112.

In more detail, the reduced pipe 114 desirably has a structure having one or more planes formed on the outer peripheral surface thereof. In case where the reduced pipe 114 of the first edge pipe 110 is inserted into the enlarged pipe 112 of the second edge pipe 110 adjacent to the first edge pipe 110, accordingly, the first edge pipe 110 is not rotated with respect to the second edge pipe 110 and is rigidly maintained in the state of being coupled to the second edge pipe 110. On the other hand, if the reduced pipe 114 and the enlarged pipe 112 are formed of generally circular pipes, the connected portions of the respective edge pipes 110 are twisted to make the body 100 hard to maintain the structure of the plane figure.

As shown in FIG. 2, for example, the reduced pipe 114 of the edge pipe 110 according to the present invention has six planes formed along the outer peripheral surface thereof, thereby providing a hexagon vertical section. At this time, if three planes are formed along the outer peripheral surface of the reduced pipe 114, the vertical section of the reduced pipe 114 becomes triangle, and if four planes are formed along the outer peripheral surface of the reduced pipe 114, the vertical section of the reduced pipe 114 becomes square.

On the other hand, each edge pipe 110 is desirably formed of aluminum, an aluminum alloy or a plastic material, which provides substantially light weight.

Referring to FIG. 2, the frame according to the present invention includes the coupling string 200.

The coupling string 200 serves to limit the moving range of the edge pipes 110 in such a manner as to prevent the edge pipes 110 disassembled from each other from being lost and also serves to rigidly maintain the outer shape of the body 100 in such a manner as to apply a restoring force to the edge pipes 110 assembled to each other. Accordingly, the coupling string 200 is formed of an expandable material, for example, a rubber string, a flexible wire or the like.

So as to allow the edge pipes 110 to be maintained in their integral structure even in their separated state, as shown in FIG. 3, the coupling string 200 is disposed inside the edge pipes 110 in such a manner as to be connected at both ends thereof.

So as to sufficiently apply the restoring force to the body 100 formed by connecting the edge pipes 110 to each other, moreover, the coupling string 200 desirably has the length in the state where no external force is applied shorter than the whole length of the edge pipes 110.

Referring to FIG. 1, the frame according to the present invention further includes a fixing pipe 300 and coupling means 400.

The fixing pipe 300 serves to allow the frame to be located well to a desired position by means of a user, and in case where the frame is used indoors or outdoors, the fixing pipe 300 is fixed to a stand or taken by a user's hand.

The fixing pipe 300 is coupled at both side ends thereof to the body 100. So as to prevent the reflecting plate installed in the frame from being contacted with the stand or the user's hand, in more detail, the fixing pipe 300 includes a first bent pipe, a second bent pipe, and a linear pipe connecting the first bent pipe and the second bent pipe to each other. At this time, the first bent pipe, the second bent pipe and the linear pipe may have a unitary body structure.

Further, the first bent pipe and the second bent pipe are coupled to both side centers of the body 100, so that the supporting force provided from the outside is transmitted uniformly to the body 100, thereby preventing the body 100 from being inclined to any one side.

On the other hand, the coupling means 400 is provided between the body 100 and each end portion of the fixing pipe 300 in such a manner as to mount the fixing pipe 300 onto the body 100. Each coupling means 400 includes first coupling means adapted to couple the first bent pipe of the fixing pipe 300 to one side of the body 100 and second coupling means adapted to couple the second bent pipe of the fixing pipe 300 to the other side of the body 100.

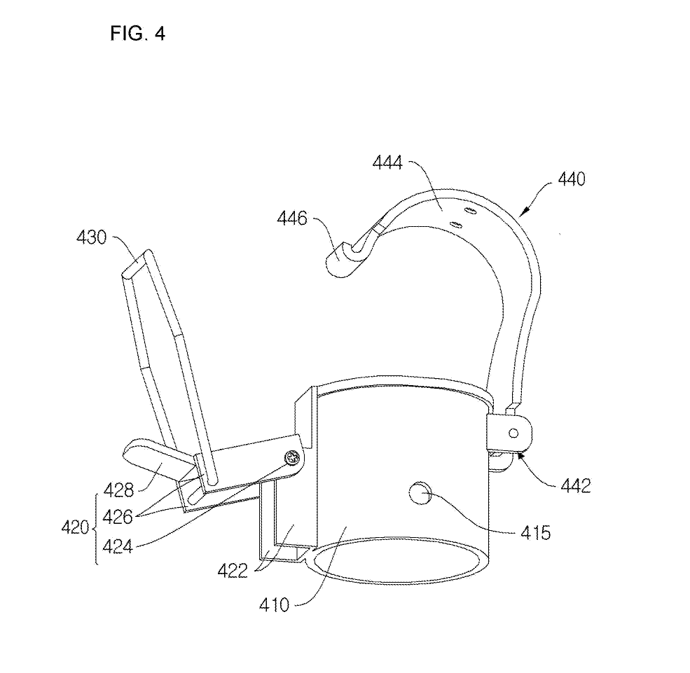

FIG. 4 is a perspective view showing an example of coupling means adopted in the present invention.

Referring to FIG. 4, the coupling means 400 applied in the present invention is provided between the body 100 and each end portion of the fixing pipe 300 in such a manner as to mount the fixing pipe 300 onto the body 100 and it includes a body portion 410 into which the fixing pipe 300 is inserted, a first hinge portion 420 adapted to be hinge-coupled to the body portion 410, and a locking hook 440 adapted to be hinge-coupled to the body portion 410 and to be fastened to the first hinge portion 420 through rotation in such a manner as to be brought into close contact with the fixing pipe 300.

In more detail, the body portion 410 has the inner diameter corresponding to the outer diameter of the fixing pipe 300 in such a manner as to insert the fixing pipe 300 thereinto. If necessary, the body portion 410 has one or more coupling holes 415 in which screw roots are formed. The coupling holes 415 are coupled to male screws or rivets, and in the state where the fixing pipe 300 is inserted into the body portion 410, thus, if the coupling depths of the male screws to the coupling holes 415 are adjusted or the rivets are fastened thereto, the fixing force of the fixing pipe 300 inserted into the body portion 410 can be improved.

Further, the first hinge portion 420 is hinge-coupled to the body portion 410 and has a pair of holes formed at the inside thereof. In more detail, the first hinge portion 420 includes: a pair of first side plates 422 protruded vertically from the side surface of the body portion 410 and having a pair of first through-holes formed at positions opposing to each other; a first rotary shaft 424 adapted to be rotated in such a manner as to be inserted into the pair of first through-holes at both end portions thereof; a pair of coupling plates 426 adapted to be contacted at ends thereof with the first side plates 422 on which the pair of first through-holes is formed and having a pair of second through-holes formed at the contacted portion with the pair of first through-holes in such a manner as to be coupled to the first rotary shaft 424 and a pair of holes formed spaced apart from the pair of second through-holes; and a pressing plate 428 protruded vertically from the top portions of the coupling plates 426 in such a manner as to connect the coupling plates 426 to each other. At this time, the pressing plate 428 has a longer length than the coupling plates 426, so that the pressurizing force applied from the user can be supplied sufficiently to the pressuring plate 428, and the other end of the pressing plate 428 corresponding to one end bonded to the coupling plates 426 is formed inclined upwardly.

Further, the pair of holes of the coupling plates 426 is coupled to a locking loop 430 in such a manner as to allow both ends of the locking loop 430 to be rotatably inserted thereinto. The locking loop 430 is coupled to or separated from the locking hook 440 by means of the application of the external force thereto, thereby controlling the mounting of the fixing pipe 300 onto the edge pipes 110, and it is of a shape of “π”.

Moreover, the locking hook 440 includes: a second hinge portion 442 adapted to be hinge-coupled to the body portion 410; a bent plate 444 adapted to be connected to the second high portion 442 and having a curved surface formed in such a manner as to be brought into close contact with the edge pipe 110; and a hook portion 446 adapted to be connected to the bent plate 444 in such a manner as to be coupled to the locking loop 430 through rotation. At this time, the second hinge portion 442 includes: a pair of second side plates protruded vertically from the side surface of the body portion 410 and having a pair of third through-holes formed at positions opposing to each other; a second rotary shaft adapted to be rotated in such a manner as to be inserted into the pair of third through-holes at both end portions thereof; and a flat plate adapted to be coupled to the second rotary shaft in such a manner as to be rotated around the second rotary shaft. In this case, the flat plate, the bent plate 444 and the hook portion 446 may be formed to a unitary body.

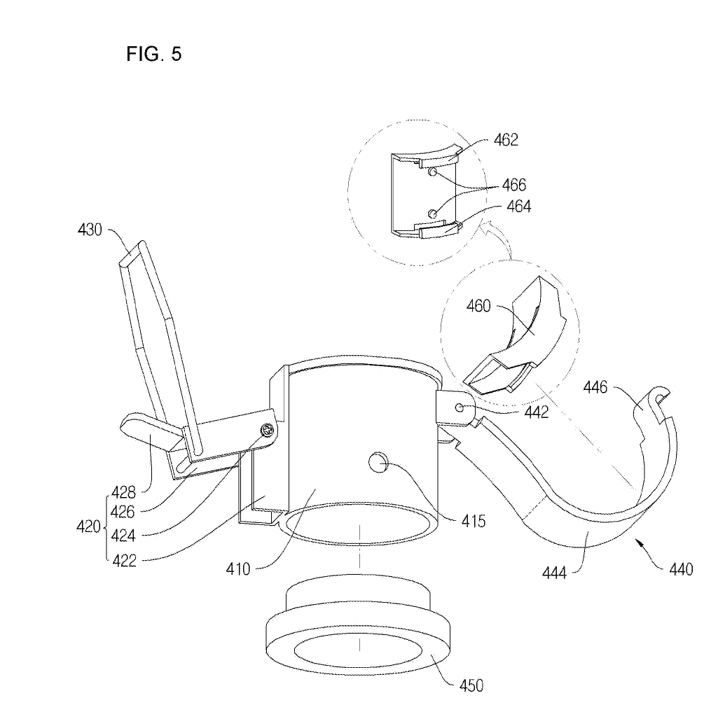

FIG. 5 is a perspective view showing another example of coupling means adopted in the present invention.

Referring to FIG. 5, the coupling means 400 applied in the present invention includes: the body portion 410 has the inner diameter corresponding to the outer diameter of the fixing pipe 300 in such a manner as to insert the fixing pipe 300 thereinto; the first hinge portion 420 adapted to be hinge-coupled to the body portion 410 and having a pair of holes formed at the inside thereof; the locking loop 430 adapted to be rotatably inserted on both ends thereof into the pair of holes of the first hinge portion 420; the locking hook 440 having the second hinge portion 442 adapted to be hinge-coupled to the body portion 410, the bent plate 444 adapted to be connected to the second high portion 442 and having a curved surface formed in such a manner as to be brought into close contact with the edge pipe 110, and the hook portion 446 adapted to be connected to the bent plate 444 in such a manner as to be coupled to the locking loop 430 through rotation; a first impact absorbing member 450 disposed inside the body portion 410 into which the fixing pipe 300 is inserted; and a second impact absorbing member 460 disposed along the surface of the bent plate 444 with which the edge pipe 110 is contacted.

Like this, the coupling means 400 as shown in FIG. 5 further includes the first impact absorbing member 450 and the second impact absorbing member 460. The first impact absorbing member 450 is made of an elastic material like PP, PE, rubber and so on and thus improves the coupling force by which the body portion 410 is rigidly coupled to the fixing pipe 300, so that while the fixing pipe 300 is being inserted into the body portion 410, the collision between the fixing pipe 300 and the body portion 410 and the damage caused thereby can be all prevented. Further, the first impact absorbing member 450 serves to adjust the inner diameter of the body portion 410, thereby allowing the fixing pipes 300 having different diameters to be all applicable.

Further, the second impact absorbing member 460 is made of an elastic material like PP, PE, rubber and so on, so that while the body portion 410 is being coupled to the edge pipe 110 by means of the locking hook 440, the collision between the body portion 410 and the edge pipe 110 and the deformation caused thereby can be all prevented. Further, the second impact absorbing member 460 serves to adjust the size of the curve formed on the bent plate 444, thereby allowing the edge pipes 110 having different diameters to be all applicable.

In more detail, the second impact absorbing member 460 has locking portions 462 and 464 formed on both sides thereof in such a manner as to be easily coupled to the bent plate 444 and one or more cylindrical protrusions 466 formed on the inner surface thereof in such a manner as to be inserted into one or more through-holes formed on the bent plate 444. Accordingly, the second impact absorbing member 460 has the same curved surface as the bent plate 444 and the locking portions 462 and 464 formed on both sides thereof in such a manner as to have “┌” and “┐”-shaped vertical sections.

One of the locking portions 462 and 464 of the second impact absorbing member 460 is first fitted to the bent plate 444 and next, the other is a little bent and fitted to the bent plate 444.

As described above, the frame for mounting a reflecting plate and a background sheet for picture and video shooting thereon according to the present invention allows the coupling and separating to be conveniently conducted, provides many conveniences in delivery and use, and occupies relatively small space when delivered and kept to substantially reduce the costs for delivery and keeping.

Additionally, even though the plurality of edge pipes is coupled to form the frame, the frame can be stably fixed, without any free turning in the coupled portions of the edge pipes, so that the reflecting plate fixed to the frame is also supported rigidly, without any distortion of the reflecting surface.

Moreover, the plurality of edge pipes is connected totally to each other by means of the coupling string even in the state of being separated from each other, thereby making it convenient to keep or assemble the edge pipes, without having any loss.

So as to allow the frame to be fixed to a stand or a user's hand when used indoors or outdoors, furthermore, the fixing pipe can be detachably mounted on the frame in one-touch manner and also can rigidly fix the frame, so that light is stably reflected and illuminated to a desired direction.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A frame for mounting a reflecting plate and a background sheet for picture and video shooting thereon, the frame comprising:
a body having a plurality of edge pipes coupled to each other to form a structure of a plane figure, each edge pipe being coupled at the end portions thereof to the edge pipe adjacent thereto; and
a coupling string disposed inside the edge pipes in such a manner as to be connected at both ends thereof to maintain an integral structure even in a state where the edge pipes are separated from each other, the coupling string having given expandability.

2. The frame according to claim 1, wherein each edge pipe has a reduced pipe disposed at one side thereof, the reduced pipe having one or more planes formed along the outer peripheral surface thereof, and an enlarged pipe disposed at the other side corresponding to one side thereof, the enlarged pipe having the inner peripheral surface having the same shape as the outer peripheral surface of the reduced pipe.

3. The frame according to claim 1, wherein the coupling string is made of a rubber string or a flexible wire.

4. The frame according to claim 1, further comprising:
a fixing pipe adapted to be coupled at both side ends thereof to the body; and
coupling means disposed between the body and each end portion of the fixing pipe in such a manner as to mount the fixing pipe onto the body.

5. The frame according to claim 4, wherein each coupling means comprises:
a body portion having the inner diameter corresponding to the outer diameter of the fixing pipe in such a manner as to insert the fixing pipe thereinto;
a first hinge portion adapted to be hinge-coupled to the body portion and having a pair of holes formed at the inside thereof;
a locking loop adapted to be rotatably inserted at both ends thereof into the pair of holes of the first hinge portion; and
a locking hook having a second hinge portion adapted to be hinge-coupled to the body portion, a bent plate adapted to be connected to the second high portion and having a curved surface formed in such a manner as to be brought into close contact with the edge pipe, and a hook portion adapted to be connected to the bent plate in such a manner as to be coupled to the locking loop through rotation.

6. The frame according to claim 5, wherein each coupling means further comprises:
a first impact absorbing member disposed inside the body portion into which the fixing pipe is inserted; and
a second impact absorbing member disposed along the surface of the bent plate with which the edge pipe is contacted.
